(19) United States
(12) Patent Application Publication
(10) Pub. No.: US 2023/0408847 A1
(43) Pub. Date: Dec. 21, 2023

(54) Optical Device with Electroactive Lens

(71) Applicant: Morrow N.V., Zwijnaarde (BE)

(72) Inventors: Peter Cirkel, Amsterdam (NL); Maarten Van Der Burgt, Leuven (BE); Jelle De Smet, Gent (BE); Varsenik Nersesyan, Gent (BE)

(21) Appl. No.: 18/250,585

(22) PCT Filed: Oct. 26, 2021
(86) PCT No.: PCT/EP2021/079677

§ 371 Date: Apr. 26, 2023

(30) Foreign Application Priority Data
Oct. 26, 2020 (NL) 2026764

(51) Int. Cl. G02C 7/08

(52) U.S. Cl. CPC G02C 7/083; G02C 2202/20

(57) ABSTRACT

The present disclosure relates to an electroactive for use in eyewear, the electroactive unit comprising: an electroactive element, the electroactive element comprising a first and a second optically transparent substrate, between which at least one liquid crystal layer comprising nematic liquid crystals; and a Fresnel-lens structure are arranged, wherein a first and a second transparent electrode are formed on the first and second substrates respectively, and wherein an alignment layer is present on the first substrate and in contact with the liquid crystal layer and is configured to align the nematic liquid crystals in a first direction, and a polarization element configured for adjusting light having a polarization in a second direction perpendicular to the first direction, wherein the liquid crystals of the liquid crystal layer are in the Mauguin regime.

### FIELD OF THE DISCLOSURE

The present disclosure relates to an optical device for use in eyewear, the optical device comprising a first electroactive lens for tunable transmission of light. The disclosure also relates to a lens unit comprising such optical device, to a pair of glasses comprising a frame provided with optical devices and a method of operating an optical device.

### BACKGROUND OF THE DISCLOSURE

Optical devices comprising a liquid crystal (LC) layer and a Fresnel lens structure as part of an electroactive lens can be switched from a state in which the refractive index of the LC in the direction of the optical axis of the lens matches with the refractive index of the lens to a state in which the refractive index in a direction perpendicular to the optical axis does not match with the refractive index of the lens. In this latter state the lens is on for polarized light with the polarization angle dependent on the LC alignment. The liquid crystal lens can be a lens made entirely of liquid crystal or a lens made of isotropic material filled with liquid crystal.

In order to make such a lens suitable for unpolarized light, such as natural light, several approaches have been proposed:
1. Stack two similar lenses on top of each other with the alignment of the liquid crystal in each lens perpendicular to each other (US201715787082).
2. Use the lens in combination with a linear polarizer with a certain orientation (U.S. Pat. No. 4,190,330A).

Some patent documents on liquid crystal tunable lenses describe lens stacking, but tend to use planar alignment and do not consider how the Fresnel-lens structures in the LC cavities are oriented with respect to each other. Even if they do, the Fresnel-lens structures are generally stacked with the surfaces oriented in the same direction. See for example: US20070216851A1, U.S. Pat. No. 9,448,456B2, U.S. Pat. No. 9,690,116B2, U.S. Ser. No. 10/863,949, US201715787082, or U.S. Pat. No. 4,190,330A.

The present disclosure relates to an electroactive lens made of isotropic polymeric material that is combined with vertically aligned liquid crystals. This type of electroactive lenses is known, for instance from U.S. Pat. No. 8,587,734. These known electroactive lenses have a number of drawbacks. For instance, the orientation in the plane perpendicular to the optical axis is influenced by the structure of the lens in the optical device. This orientation is different in different parts of the optical device. Therefore in the approaches mentioned above the device will in some parts not only transmit an enlarged image but also a non-enlarged image. This leads to a double image.

A double image appears in an on state of an electroactive unit when the tilt angle of the homeotropically oriented liquid crystal is small and the off axis (with respect to the unidirectional tilt orientation) local lens surface inclination is large.

A switchable lens consisting of an isotropic polymeric lens and an applied vertically aligned liquid crystal is known from U.S. Pat. No. 8,587,734. The lens is made by imprinting a polymeric layer on one substrate. In this process spacers are formed as well, to keep a second substrate at a certain distance from the lens. The cavity between the substrates covered with transparent electrodes is filled with liquid crystal. Along the substrates the orientation of the liquid crystal is determined by several factors. The orientation in the off-state is controlled by a polyimide layer serving as an alignment layer. In general, this layer orients the liquid crystal director (wherein the liquid crystal director is defined as the average direction of the long molecular axes of the liquid crystal molecules) homogeneously perpendicular to the surface, also know as vertical alignment. If then the voltage is applied over the electrodes, the liquid crystal will reorient randomly in the plane along the surfaces. Rubbing of the alignment layer on a substrate, for instance rubbing polyimide-covered substrates, results in a small deviation of the director from the perpendicular orientation in the off-state. An additional description of the concept of including a pretilt by rubbing (or similar techniques, such as photo alignment) on an alignment layer in an electroactive lens is provided in WO 2019/038439 A1, the content of which is herein incorporated by reference.

The deviation of the director is related to the rubbing direction and is called a pretilt. When the voltage is applied, the orientation on the opposite substrate to the lens is determined by the rubbing direction only. On the substrate with the lens, the situation is more complicated. The orientation of the liquid crystal director is affected by the rubbing direction as well as by the geometry of the lens surface. Since the orientation of the lens surface is different at different positions, the liquid crystal director is also inhomogeneous over the lens substrate. This is why in some parts the orientation of the director is different for the top and bottom substrates and a twist of the director will occur. Note that similar alignment (i.e. application of a suitable pretilt) can be achieved by photo alignment techniques.

### SUMMARY OF THE DISCLOSURE

It is an object of the present disclosure to provide an optical device comprising at least one tunable electroactive lens providing an improved optical quality, and/or a reduced risk of the occurrence of double images.

It is a further object to improve the optical quality and reduce the occurrence of optical artefacts such as double images in case the light that is to focused or dispersed by the electroactive lens is unpolarized light.

According to a first aspect an optical device for use in eyewear is provided, wherein the optical device comprises a first electroactive lens for tunable focusing or dispersing of light, the electroactive lens comprising:
a first and a second optically transparent substrate, wherein the first and second optically transparent substrates extend generally parallel to each other and define an axial (z) direction and transverse (x,y) directions;
a diffractive lens structure, such as a Fresnel lens structure, arranged between the first and second optically transparent substrate at the side of the second optically transparent substrate;
a first optically transparent electrode formed on the first optically transparent substrate and a second optically transparent electrode formed on the second optically transparent substrate or on the diffractive lens structure;
a sealed cavity (108) between the first and second optically transparent substrates, wherein in the sealed cavity the diffractive structure and at least an LC layer of nematic liquid crystalline (LC) material are arranged and wherein liquid crystals in the nematic liquid crystalline (LC) material are generally axially aligned in an off-state;
wherein the first optically transparent electrode comprises an alignment layer having a contact surface in contact with the LC layer and configured to linearly align liquid crystals in the nematic liquid crystalline material in a first horizontal direction in an on-state by introducing a pretilt in the off state;
a polarization element configured for adjusting light having a polarization in a second horizontal direction perpendicular to the first horizontal direction;
wherein the LC layer of nematic liquid crystalline material has a thickness (D), measured between the portion of the diffractive lens structure closest to the first optically transparent electrode and the contact surface of the alignment layer on the first optically transparent electrode, and
wherein the thickness (D) is selected to satisfy the condition 1<(πD(nₑ−nₒ)/(φλ)<200, nₒ being the ordinary refractive index of the LC layer, nₑ the extraordinary refractive index of the LC layer, φ the twist angle of the liquid crystal director of the LC layer and λ the wavelength of the light, the wavelength a ranging between 350 nm and 750 nm.

The twist angle may range from 0 to 180 degrees.

The pretilt caused by the alignment layer and, if present, by the further alignment layer discusses hereafter, provides a relatively small deviation of a perfect axial alignment. In embodiments of the present disclosure the pretilt (which defines a small deviation from a perfect axial (vertical) alignment) typically varies between 1 and 6 degrees relative to the axial (z-) direction. Reference is also made to WO 2019/038439 A1 filed by the same inventors, wherein a further explanation is provided about how the inclusion of a small pretilt may assist in the proper alignment of the LC material in the off-state and on-state.

When the condition is satisfied the liquid crystals of the liquid crystal layer are well within the Mauguin regime so that waveguiding in the liquid crystal layer takes place. This makes it possible to maintain a linear polarization of the light traveling through the optical device. Furthermore, since a specific linear alignment direction may be applied to the first optically transparent electrode by use of the alignment layer of the first optically transparent electrode, a suitable response of the optical device that is uniform over the surface optical device can be achieved. Additionally, by maintaining the linear polarization it is possible to filter out any unwanted artefacts such as double images. The filtering out can be achieved in certain embodiments by including a linear polarizer into the optical device, while in other embodiments this is achieved by providing a second electroactive lens stacked on top of the first electroactive element, as will be explained hereafter. For instance, in embodiments of the present disclosure, the above-mentioned polarization element comprises a polarizer (preferably a linear polarizer) configured to allow light with a first linear polarization through and substantially block light with a second linear polarization perpendicular to the first linear polarization. Alternatively or additionally, in other embodiments of the present disclosure, the above-mentioned polarization element comprises a second electroactive lens, preferably similar to the first electroactive lens, stacked on the first electroactive lens.

The optical device as defined herein may comprise first and second substrates and/or first or second alignment layers that are substantially flat and that are arranged to generally extend parallel to each other. In these embodiments the axial alignment corresponds to a vertical alignment when the flat substrates and/or flat alignment layers are arranged to extend in horizontal direction. In other embodiments the first and second substrates and/or first or second alignment layers may be curved elements, wherein these curved elements are arranged to still extend generally parallel to each other. In these embodiments the axial alignment of the nematic liquid crystalline (LC) material defines an alignment in a direction that is locally perpendicular to the surface of the substrate/alignment layer facing the sealed cavity. In other words, at every location of the surface an axial direction may be defined which is the direction perpendicular to the local orientation of the surface of the substrate/alignment layers. This direction generally is different for different locations on the surface. Hence, in embodiments having curved substrate and alignment layers it is preferred to refer to “axial alignment” rather than to “vertical alignment”.

While an alignment layer is generally required on the diffractive lens structure to axially (vertically) align the liquid crystals in the off-state, introducing a directional pretilt is not strictly needed. In the on-state, a non uniform director profile will be present at the diffractive lens structure, leading to varying twist angles which are highly dependent on the local diffractive lens structure. However, introducing a pretilt in the same transversal (horizontal) direction as the linear alignment direction of the alignment layer on the first optically transparent electrode, will generally reduce the twist angle values and thus increase the Mauguin condition value. This will lead to better optical performance.

Throughout the present disclosure when reference is made to liquid crystals in the nematic liquid crystalline (LC) material being generally axially aligned means that that an essential portion of the liquid crystals are aligned in a uniaxial direction.

According to embodiments of the present disclosure the diffractive lens structure arranged between the first and second optically transparent substrate at the side of the second optically transparent substrate is arranged at the second optically transparent layer. The second optically transparent electrode may be formed on the diffractive lens structure. According the embodiments of the present disclosure the diffractive lens structure arranged between the first and second optically transparent substrate at the side of the second optically transparent substrate is arranged at the second optically transparent electrode, wherein the second optically transparent electrode is arranged on the second optically transparent substrate.

According to embodiments of the present disclosure the polarization element comprises a second electroactive lens stacked on the first electroactive lens. The first optically transparent layer of the first electroactive lens comprises an alignment layer having a contact surface in contact with the LC layer and configured to linearly align liquid crystals in the nematic liquid crystalline material in a first horizontal direction in the on-state, while the first optically transparent layer of the second electroactive lens comprises an alignment layer having a contact surface in contact with the LC layer and configured to linearly align liquid crystals in the nematic liquid crystalline material in a second horizontal direction in the on-state, wherein the first direction is perpendicular to the second horizontal direction. In this manner the optical device is able to transmit (i.e. to disperse or focus) unpolarized light through the electroactive lenses with improved accuracy, thereby avoiding or at least reducing the likelihood of the occurrence of double images.

Preferably the optical power of the first electroactive lens corresponds to the optical power of the second electroactive lens so that in the on-state of the optical device the lens action provided by the optical device for a first linear polarization direction correspond to the lens action for a second linear polarization direction (the second direction being orthogonal to the first direction).

The first and second electroactive lenses may be identical, which may be advantageous in view of manufacturing costs. However, the first and second electroactive lenses may differ as well. For instance, in embodiments wherein the diffractive lens elements of both electroactive lenses are Fresnel lens structures, the blaze axial heights and/or the blaze transversal positions of the Fresnel lens structure of the first electroactive lens may differ at least partially from the blaze axial heights and/or the blaze transversal positions of the Fresnel lens structure of the second electroactive lens. This may help to reduce parallax effects and Moire-effects in case of observation from oblique directions, for instance.

Additionally or alternatively, the nematic liquid crystalline material of the first electroactive lens may differ from the nematic liquid crystalline material of the second electroactive lens. Using different nematic liquid crystalline materials may help reduce parallax effects and Moire-effects in case of observation from oblique directions. Furthermore, the choice of nematic liquid crystalline material may influence the required positions of the blazes of the diffractive structure and/or may reduce the occurrence of chromatic aberrations.

In some embodiments wherein a first and second electroactive lens are stacked, the first optical transparent substrate of the first electroactive lens and the first optical transparent substrate of the second electroactive lens are combined into a single, common optical transparent substrate. The stack of electroactive lenses then may only have three substrates.

Instead of stacking two electroactive lenses on top of each other, a single electroactive lens may be provided with at least one linear polarizer. The linear polarizer is configured to allow light with a first linear polarization through and substantially block light with a second linear polarization perpendicular to the first linear polarization. Furthermore, the polarizer is preferably aligned at the side of the first optically transparent layer in such a manner that the first linear polarization is substantially parallel to the alignment of the liquid crystals in the liquid crystal layer at the position near the first electrode. In other words, the polarizer axis may be aligned with the direction of the liquid crystal director in the nematic liquid crystalline (LC) material of the first electroactive lens in the on-state. In this manner incoming unpolarized light (when the optical device is in the on state) will result in an enlarged image originating from light of a first polarization along the first linear alignment direction and a non-enlarged image originating from light of a second polarization perpendicular to the first direction. Now the non-enlarged image may be easily filtered by a suitable polarizer.

In preferred embodiments the linear polarizer comprises one or more polarizing layers attached to the first substrate and/or to the first optically transparent electrode, more preferably the linear polarizer comprises a polarizing layer attached to the alignment layer and aligned to the alignment direction of the alignment layer. Note that the alignment direction may be accomplished in different manners and may correspond to a rubbing direction when the alignment layer has undergone a rubbing operation or to a photo alignment direction when the alignment layer has undergone a photo alignment treatment.

In a further embodiment the optical device comprises at least one polarizing layer formed on the surface of the diffractive lens structure facing the LC layer, wherein the polarizing director of the at least one further polarizing layer is tuned in different areas of the diffractive lens structure in such a way that it matches the local liquid crystal director on the lens surface.

The optical device may of the type wherein the at least one electroactive lens is configured to tune the focusing or dispersing of light by altering the alignment of liquid crystals in the LC layer, upon application of a voltage to the optically transparent electrodes. As will be appreciated by the skilled person, the voltage can be applied in different manners. One specific example of attaching the electrodes of the electroactive lens or lenses to a power source, such as a battery arranged in a different part of the frame of a pair of glasses is described in WO 2019/101966 A1. Furthermore, the optical transparent electrodes of the electroactive lenses may be electrically connected for simultaneous switching of the first and the second electroactive lenses. Tuning of the focusing or dispersing of the light may bring about a variation of the optical power of the electroactive lens by altering the refractive index of the LC layer in the transverse direction upon application of a voltage to the optically transparent electrodes, as this reorients the LC director towards the transverse direction.

The optical device may be configured to cause the at least one electroactive lens to switch from an the off state wherein the at least one electroactive lens shows essentially no lens action and an on state wherein the at least one electroactive lens shows lens action upon application of a voltage to the optically transparent electrodes of the at least one electroactive lens. Depending on the type of diffractive lens element the lens action may involve enlarging of the incoming image.

In the off-state the liquid crystals in the nematic liquid crystalline material are orientated such that the refractive index of the LC layer in the transverse direction essentially matches the refractive index of the diffractive structure and/or wherein in the on-state the orientation of the liquid crystals is tilted so that the orientation becomes parallel with the alignment direction of the alignment layer.

The optical device may comprise a plurality of spacers that are arranged in the liquid crystal layer, extending in a direction perpendicular to a plane wherein the second electrode extends, which spacers are preferably formed on the diffractive lens structure. The spacers ensure that the required minimum and maximum thickness of the LC layer can be accurately achieved. In specific embodiments the spacers are configured to provide an additional height, measured from the portion of the diffractive lens structure closest to the second substrate, between 1-20 μm, preferably 2-12 μm.

The liquid crystalline material of the LC layer is preferably selected to have a birefringence Δn that is in the range of 0.15-0.40.

According to another aspect a lens unit for use in eyewear is provided, the lens unit comprising a first lens part, a second lens part and an optical device as defined herein, wherein the electroactive lens is arranged, preferably sandwiched, between the first lens part and second lens part.

According to still another aspect a pair of glasses is provided, wherein the glasses comprise a frame in which a first and second lens unit or a first and second optical device as defined herein are mounted.

According to yet another aspect a method of operating an optical device comprising a first and second electroactive lens as defined herein is provided, wherein an alternating voltage is applied onto the first and second electrode of the first electroactive lens and of the second electroactive lens stacked onto the first electroactive lens, so as to align the liquid crystals in a direction substantially perpendicular to the first and second substrates. The present disclosure also relates to the use of the optical device, the lens unit and/or the glasses as defined herein.

### General Description

Being a uniaxial material, liquid crystal owes a property of birefringence. It means that there are always two rays emerging from a liquid crystal layer that possess a certain phase retardation:

$$Γ = \frac{2 π d}{λ} ( {n}_{e} - {n}_{o} )$$

where d is the thickness of the layer, λ is the wavelength of the incident light and nₑ−nₒ=Δn is the birefringence, where nₑ is the extraordinary refractive index and nₒ is the ordinary refractive index. Angle φ below indicates the twist angle of the liquid crystal director and varies linearly with a distance d in a z-direction (i.e. the thickness of the LC-layer). A Mauguin condition is satisfied when:

$$\frac{π d Δ n}{φλ} ≫ 1$$

When the Mauguin condition is satisfied a waveguiding of the input polarization takes place. Then both, the extraordinary and ordinary waves follow the rotation of the optical axis and the liquid crystal serves as a polarization rotator.

In the liquid crystal lens the refractive index of the lens material may be matched with one of the refractive indices of the liquid crystal i.e. nₑ or nₒ. This means that there is no lens action for linearly polarized light in the direction of matched refractive index. For polarized light perpendicular to this, all the light will be refracted by the lens. If unpolarized light, which can be decomposed into two orthogonal polarization directions, will be transmitted, half of the light will encounter a lens action and half of it will not. Thus a double image will be transmitted. In order to have all the light encounter a lens action one solution is to add a second liquid crystal lens, in which the liquid crystal is perpendicular to the first one. This is also suggested in U.S. Pat. No. 7,724,347 and US201715787082. However in both patents the liquid crystal arrangement is different from the present disclosure in the way of stacking two liquid crystal layers.

In the case of the present disclosure the liquid crystal director is non-uniformly oriented on the substrate with the Fresnel-lens structure, whereas it is uniformly oriented on the counter substrate (without a Fresnel-lens structure). When stacking two lenses, if the substrate with the Fresnel-lens structure is put against the other lens, it is impossible to have the liquid crystal director to be perpendicular to the substrate it touches on the second lens in every part of the lens. This is only possible if the two lenses are stacked together with the counter substrates facing each other.

Another solution to make an electroactive lens working for unpolarized light is to add a polarizer to the lens. In this case the polarizer axis should be aligned with the liquid crystal director. Since the liquid crystal director is uniform only at the counter substrate of the lens the (linear) polarizer should be attached to this substrate and aligned to the liquid crystal (=rubbing or photoalignment) direction.

In a further solution a polarizer is added to the electroactive lens as well. However in this case it is a special type of polarizer in which the polarizer director is tuned in different area's of the lens in such a way that it matches the local liquid crystal director on the lens surface. This polarizer is attached to the lens substrate. This kind of polarizer can be made by photo alignment (see for instance: Photoalignment of liquid crystal materials: Physics and applications by V. G. Chigrinov et al).

As mentioned before, in order to have a pure split into one polarization for the magnified image and one polarization for the non-magnified image the liquid crystal twist should be to a large extend in the waveguiding regime. This means that the Mauguin condition should be satisfied, which we for the sake of clarity rewrite here as: 0.5pΔn>>λ, for λ is the wavelength of the light, p the helical pitch (equal to 2πd/φ) and Δn the birefringence. The pitch is the length in which the director of the liquid crystal twists for 360 degrees.

For example, in a condition λ is the wavelength of the light, typically 0.5 micron. Δn is the difference in refractive index along the ordinary and extraordinary axis, typically 0.2 and p is the helical pitch. This means that in order to satisfy the Mauguin condition, considering the alignment geometry, the helical pitch p should be much larger than 0.5/(0.5×0.2)=5 micron.

The amount of twisting in an electroactive lens depends on how much the lens structure alters the direction of the director between the two surfaces of liquid crystal contact, in the case of the present disclosure, between the lens surface and the opposite substrate (counter substrate).

Finite-element numerical calculations were applied by the inventors to determine the twist behavior of the liquid crystal in the electroactive lens and found that it is depending on the pretilt angle of the liquid crystal on the lens surface. This pretilt angle can be influenced by the alignment material, the rubbing or illumination conditions as well as the surface angle of the polymeric (Fresnel) lens with respect to the substrate it resides on. Generally, for lower pretilts the twist becomes larger. For instance, a pretilt of 87 degrees on a surface with an angle of 3 degrees perpendicularly oriented to the alignment direction results in a total twist of 45 degree.

Considering a cross-section of the electroactive lens that is perpendicular to the aligned surfaces, the twist values vary with the change of azimuth angle. When the sides of a cross-section coincide with the rubbing direction, the twist between the lens and the counter substrate should be 0 deg. However, with the change of azimuth the twist angle values increase and in theory may reach a value of 180 deg. In this case, the director on the Fresnel lens surface and on the counter substrate are oriented parallel to each other and instead of bend deformation the director choses to twist. This choice happens when the system tries to reach the equilibrium and an overall minimal energy state corresponds to twist of 180 deg. For the large twist values the distance between the two substrates should be larger than 2.5 micron. To this end spacers are applied which are at least 4 micron higher than the tops of the blazes for a lens with a 1.5 diopter lens power (diameter 21 mm, Δn=0.2).

Depending on the lens power and diameter, the spacer height on top of the lens should be optimized as to satisfy the Mauguin regime across the whole lens surface.

If the condition is met for the waveguiding/Mauguin regime a linear polarization of the light coincides with the twist of the liquid crystal molecules. It is this effect that the inventors have found to be usable to improve quality of electroactive lenses.

Hereby, if a linear polarization is maintained through the lens cell, and a linear alignment direction is applied to the counter substrate, then there is a uniform optical response to this surface. More specifically, there will be an enlarged image along the linear alignment direction and a non-enlarged image perpendicular thereto. So if a linear polarizer is placed on that side, the non-enlarged image can be filtered out without any problems. Moreover, it is then also possible to make a polarization-independent switchable lens by stacking a similar electroactive lens on the first electroactive lens, provided that both counter substrates are oriented towards each other and are placed at an angle of 90 degrees.

### BRIEF DESCRIPTION OF THE DRAWINGS

FIG. 1 illustrates an embodiment of an optical device comprising an electroactive lens;

FIG. 2 illustrates a twist of liquid crystal in an electroactive lens;

FIG. 3A illustrates alignment of liquid crystal in an electroactive lens;

FIG. 3B illustrates alignment of liquid crystal of two liquid crystal layers of respective electroactive lenses;

FIG. 4 illustrates an example of polarization dependent magnification by an electroactive lens;

FIG. 5 illustrates an electroactive lens provided with a polarizer layer according to an embodiment of the present disclosure;

FIG. 6 illustrates an electroactive lens provided with a polarizer layer according to another embodiment of the present disclosure;

FIG. 7 illustrates an embodiment of a lens unit comprising a first lens part, a second lens part and the optical device of FIG. 5 sandwiched between the two lens parts;

FIG. 8 illustrates an embodiment of an optical device comprising two stacked electroactive lenses corresponding to the embodiment of FIG. 1;

FIG. 9 illustrates an electroactive unit comprising a stack of two electroactive lenses according to the present disclosure; and

FIGS. 10A-10C illustrate several exemplary test results of electroactive lenses according to embodiments of the present disclosure.

### DETAILED DESCRIPTION OF THE DRAWINGS

In the following description, for the purposes of explanation, numerous specific details are set forth in order to provide a thorough understanding of the present disclosure. It will be apparent, however, that the present disclosure may be practiced without these specific details. In other instances, well-known structures and devices are not described in exhaustive detail, in order to avoid unnecessarily obscuring the present disclosure.

As will be apparent to those of skill in the art upon reading this disclosure, each of the individual embodiments described and illustrated herein has discrete components and features which may be readily separated from or combined with the features of any of the other several embodiments without departing from the scope of the present disclosure. Any recited method can be carried out in the order of events recited or in any other order which is logically possible.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

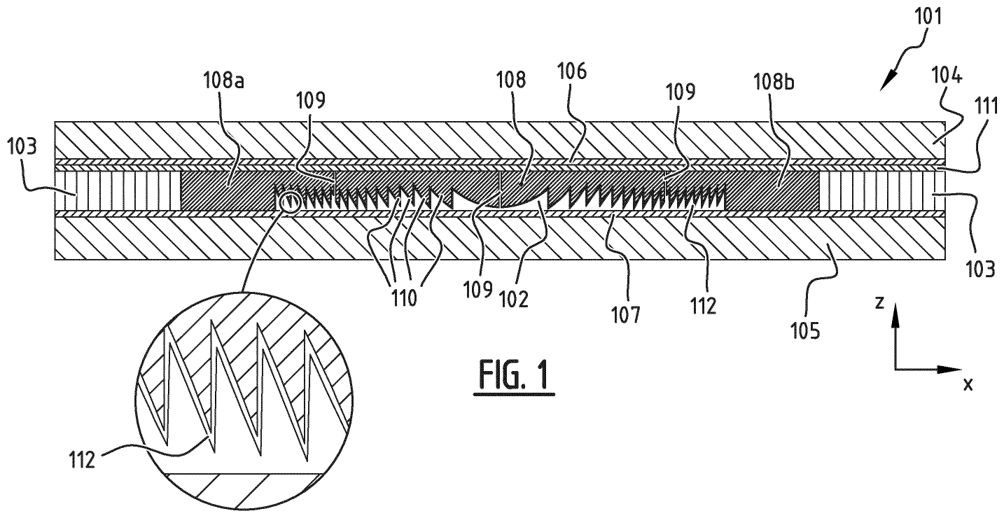

FIG. 1 shows an electroactive lens 101. The electroactive lens 101 may be part of a lens. The electroactive lens 101 comprises a first substrate 104 at which a first electrode 106 is formed, a second substrate 105 at which a second electrode 107 is formed, and a volume or cavity 108 enclosed between the first and second substrate 104, 106, in the specific embodiment between the electrode 106,107, and sealed by two borders 103 arranged at opposite ends of the electroactive lens 101. The first substrate 104, second substrate 105, first electrode 106 and second electrode 107 may be made of an optically transparent material. For instance, the electrodes 106, 107 may comprise tin-doped indium oxide (ITO) layers and/or indium-zinc oxide (IZO) layers. The first and second electrodes 106, 107 may be connected to an electrical power source (not shown). The power source may be configured to apply a voltage difference between the first and second electrodes when the optical device is switched into an on-state while in an off-state essentially no voltage difference exist between the first and second electrodes.

The sealed volume or sealed cavity 108 between the optically transparent electrodes 106, 107 contains a diffractive lens structure 102 and at least a nematic liquid-crystal (LC) layer 113 formed of nematic liquid crystals. The cavity 108 of the electroactive lens 101 may comprise a diffractive lens structure in the form of a Fresnel lens structure although other types of diffractive structures could be employed as well. The diffractive structure 102 extends in the shown embodiment over only a part of the width of the cavity 108 so that at both lateral ends of the diffractive structure a respective intermediate space 108a, 108b is present. In other embodiments, however, the diffractive structure extends to contact the two borders 103 (which borders 103 may be formed by plugs arranged between the first and second substrates 104, 105. Furthermore, the Fresnel-lens structure 102 is positioned in the center of the cavity 108, although in other embodiments the Fresnel-lens structure may be arranged closer to either of the borders 103 of the electroactive lens 101. The Fresnel-lens structure 103 is made of transparent material as well, for instance an isotropic polymeric material.

Additionally, one or more spacers 109 may be arranged inside the volume 108 as well. Spacers 109 may be arranged between the Fresnel-lens structure 102 and an opposing electrode 106, 107. For example, as illustrated in FIG. 1, the Fresnel-lens structure 102 may be arranged on the second electrode 107. The one or more spacers 109 are then arranged between the Fresnel-lens structure 102 and the first electrode 106 and extend through the volume 108. One or more spacers (not shown) may also be arranged in between the electrodes 106, 107, extending from the first electrode 106 through the volume 108 to the second electrode 107.

Furthermore on top of the first electrode 106 (or as part of the first electrode 106) an alignment layer 111 is arranged for aligning the LC material 113 inside the cavity 108. Optionally, a second alignment layer 112 is arranged on top of the diffractive structure 102, i.e. on the surface of the diffractive structure 102 facing the LC material in the cavity 108. In embodiments wherein the second electrode layer is present on top of the diffractive structure instead of being arranged between the second substrate 105 and the diffractive structure 102 (not shown in FIG. 1), the second alignment layer 102 may be part of the second electrode 102.

The electrodes 106, 107 are configured to alter the alignment of liquid crystals inside the liquid-crystal (LC) layer so as to thereby alter the refractive index of the liquid-crystal (LC) layer in the transverse direction (x-direction of FIG. 1) of the electroactive lens 101. More specifically, it is the refractive index in transversal (horizontal) direction which is the one that needs to be either matched or not matched with the one of the diffractive structure. Thereby a variation in the optical power of the electroactive lens 101 may be obtained. The alignment of the liquid crystals can be changed by activation of the electroactive lens 101. The electroactive lens 101 is configured to be activated using a voltage applied to the optically transparent electrodes 106, 107, as will be explained later.

When no voltage is applied to the electrodes 106,107 the orientation of the liquid-crystal molecules in the nematic liquid crystal (LC) is determined by the alignment layers. More specifically, the liquid crystal molecules in the nematic liquid crystal (LC) layer exhibit both in-plane and out-of-plane orientation wherein the in-plane alignment direction of the liquid crystals typically coincides with the rubbing or illumination direction. The average upward tilt angle of the liquid crystals from the aligned surface plane is then referred to as the (unidirectional) pretilt angle. When a voltage is applied to the electrodes 106, 107, then the electric field generated between the electrodes 106, 107 will cause a different alignment direction of the liquid crystals.

For example, in a first state, herein also referred to as the off-state, i.e. a state wherein no voltage is applied to the optically transparent electrodes 106, 107, the liquid crystals may orient themselves in such a manner that the refractive index of the LC layer in the transverse direction (x-direction) of the electroactive lens 101 essentially matches the refractive index of the diffractive lens structure 102. Consequently, the diffractive lens structure 102 and the LC layer effectively form a combined optical layer having one and the same refractive index in the transverse (x-direction) direction (i.e. essentially no optical interface is present in the volume 108). In other words, the combined optical layer has an essentially constant refractive index in the volume 108, irrespective of the width position (i.e. position along the x-direction shown in FIG. 1). Furthermore, the combined optical layer also has two parallel surfaces. Consequently, a beam of light, incident on the electroactive lens 101 when in the first state, will not be collimated or dispersed.

In a second state, herein also referred to as the on-state, i.e. a state wherein a voltage is applied to the first and second electrode 106,107, the orientation of the liquid-crystal molecules typically becomes parallel with the alignment direction of the alignment layers, so that an additional optical interface is created between the liquid crystals in the LC layer and the diffractive lens structure 102. This additional optical interface results in a different refractive index of the combined layer. Therefore, a light beam incident on the electroactive lens 101 will be refracted by the optical interface between the diffractive lens structure 102 and the LC-layer, thereby collimating or dispersing rays of the beam incident on the diffractive lens structure 102.

In summary, the first state may be a state wherein no voltage is applied to the electrodes 106, 107 and the second state is state wherein a suitable voltage is applied to the electrodes 106, 107 so that the refractive index of the combined optical layer in the transverse direction of the electroactive element 101 respectively matches and differs from the refractive index of the diffractive lens structure 102 (for instance a Fresnel-lens structure). Similarly, in the following description, a switched on state refers to a state wherein additional optical power is provided to the electroactive lens 101 by creating a refracting optical interface between the diffractive lens structure 102 and the liquid crystals in the volume 108, while the switched off state refers to a state wherein the refractive index of the liquid crystals in the transverse direction of the electroactive lens 101 matches the refractive index of the diffractive lens structure 102 as a result of which no additional power is provided to the electroactive lens 101. Preferably the refractive index of the LC layer (in the switched off state) and Fresnel-lens structure 102 matches the refractive index of the first substrate 104 and/or second substrate 105 as well.

The Fresnel-lens structure 102 may be a positive Fresnel-lens structure or a negative Fresnel-lens structure. Preferably, the Fresnel-lens structure 102 is a negative Fresnel-lens structure (as illustrated in FIG. 1). It may differ among applications of the electroactive lens 101 what kind of Fresnel-lens structure 102 is used, for example, different sizes, strengths, shapes of Fresnel-lens structures 102 may be used. The Fresnel-lens structure 102 may be arranged on the electrode 107 that is connected to the second substrate or, in embodiments wherein the electrode is arranged on top of the Fresnel-structure 102, the Fresnel-structure may be connected to the second substrate. In embodiments wherein the Fresnel-structure 102 is arranged on the electrode 107, the Fresnel-structure 102 may be formed on electrode 107 by any technique, for instance by nanoimprint lithography. The Fresnel-lens structure 102 may be formed by a plurality of concentric ring-like shapes referred to as blazes 110. A blaze 110 is formed by a ring-like shape having a cross-section that resembles a triangle-like shape with one of the sides extending in the axial direction (i.e. z-direction) of the electroactive lens 101, a side that is facing the electrode whereon the Fresnel-lens structure 102 is formed (i.e. xy-plane), and an oblique side (which may be curved), that provides the refracting optical interface between the Fresnel-lens structure 102 and the liquid crystal in the switched on state. The shape of the blazes 110 may be optimized for the specific application of the electroactive lens 101 and the example discussed above or the exemplary figures are non-limitative.

The first substrate 104 and the second substrate 105 may be joined by applying an adhesive between the two substrates, thereby forming at least a portion of the border 103. The adhesive joining the first substrate 104 and the second substrate 105 may for example be NOA71 or NOA160. The border 103 or part of the border may further be formed during the formation of the Fresnel-lens structure 102, for example, during the nanoimprinting step wherein the Fresnel-lens structure 102 is formed.

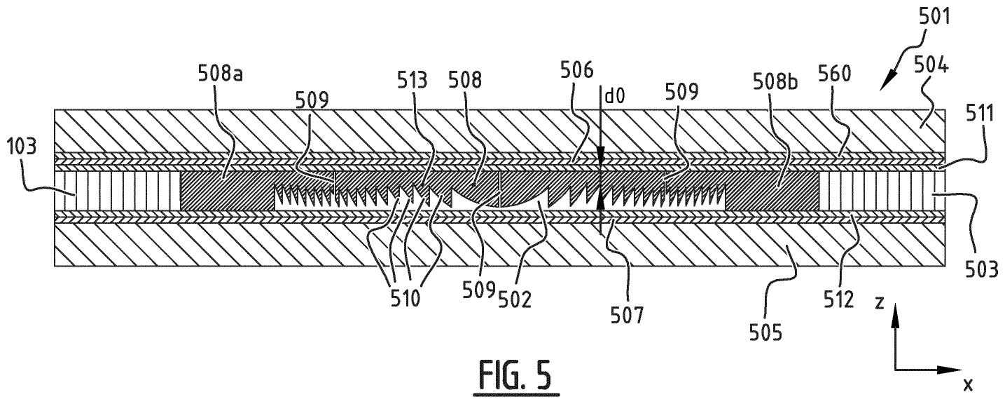

The same description as above in the light of FIG. 1 may also apply to the embodiment shown in FIGS. 5-7, herein like reference numerals may refer to like elements.

The nematic liquid crystals in electroactive lenses like in FIG. 1 may cause double refraction to occur due to the birefringent properties of the liquid crystals. As illustrated in FIG. 4, in an on state of the electroactive lens, the electroactive lens provides lens power. However, due to the birefringent properties of the liquid crystals, different polarizations are refracted differently.

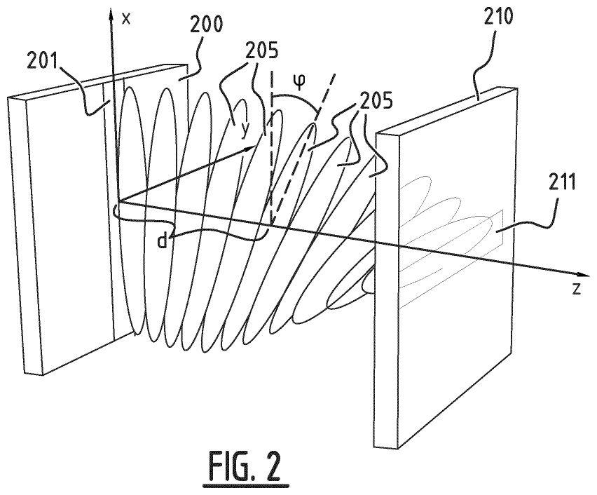

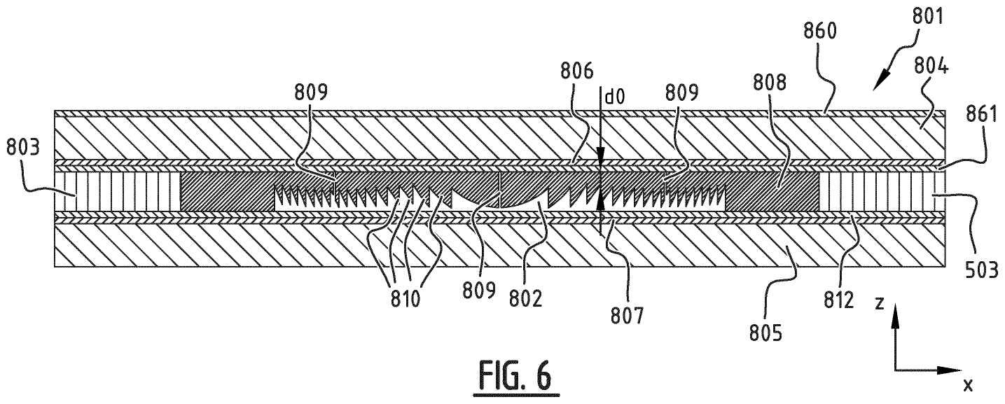

For example dot 402 and dot 403 ideally coincide to form a singe dot. However, due to the different refraction of the different polarizations, these dots appear to be separated in the enlarged image 401. In the following description, in the light of FIGS. 2-4, this problem will be further elucidated, followed by how this problem is addressed in the light of FIGS. 5, 6 and/or 7. FIGS. 8A-8C are illustrative measurements illustrating the success of the proposed solutions.

FIG. 2 illustrates a liquid crystal layer comprising liquid crystals 205 arranged between two surfaces 200, 210. Being a uniaxial material, liquid crystals owe the property of birefringence. It means that there are always two rays emerging in a layer possessing a phase retardation:

$$Γ = \frac{2 π d}{λ} ( {n}_{e} - {n}_{o} )$$

where d is the thickness of the layer, λ is the wavelength, nₑ is the extraordinary refractive index, nₒ is the ordinary refractive index and (nₑ−nₒ)=Δn being the birefringence. Angle φ in equation (1) and in FIG. 2 indicates the twist angle of the liquid crystal director and varies linearly in z direction. When the Mauguin condition is satisfied, i.e.,

$$\frac{π d Δ n}{ϕ λ} ≫ 1 \qquad ( 1 )$$

a waveguiding of the input polarization takes place. Then both, the extraordinary and ordinary polarizations of the incident light follow the rotation of the optical axis and liquid crystals 205 serve as a polarization rotator.

In the liquid crystal layer in an electroactive lens such as described in the light of FIG. 1 the refractive lens material 102 is matched with one of the refractive indices of the liquid crystal i.e. (nₑ or nₒ). This means that there is no lens action for linearly polarized light in the direction of matched refractive index. For polarized light having a polarization perpendicular to this, all the light will be refracted by the lens. If unpolarized light, which can be described as a superposition of light of two orthogonal polarization directions, is transmitted, half of the light will encounter a lens action and half of it will not. Therefore a double image will be transmitted.

In other words, the birefringent liquid crystals 205 disposed in between the surfaces 201 and 210, the liquid crystals 205 tend to twist over an angle φ over a distance d. As explained above, the liquid crystals 205, when the Mauguin condition is satisfied, (wave-) guide the input polarization. As such, if, for example, light is incident on transparent surface 200 in the z-direction, a polarization of said light in the x-direction will experience another refractive index of the liquid crystal layer than another polarization of light that has a polarization direction (at surface 200) in the y-direction.

The twisting of liquid crystals 205 may not only be influenced by the thickness of the layer in between surfaces 200 and 210 but also by known methods such as rubbing or photoalignment of the alignment layers. Further, also the orientation of a second surface 210 with respect to the first surface 200 affects the twisting of liquid crystals 205. For example, if the second surface is rotated in yz-plane, the liquid crystals 205 will rotate in another manner than as currently illustrated in FIG. 2. This may, for example, occur at a position of a blaze 110.

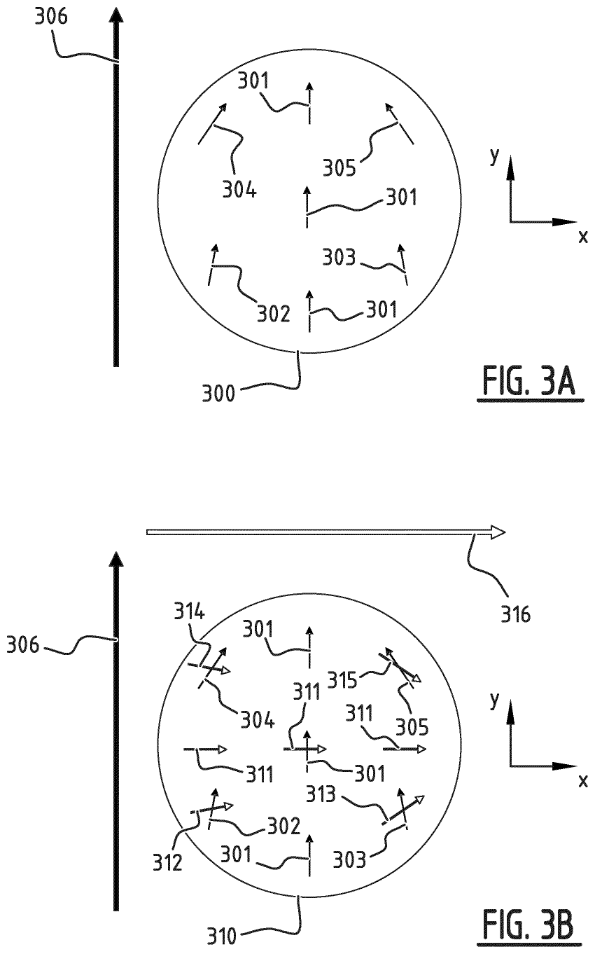

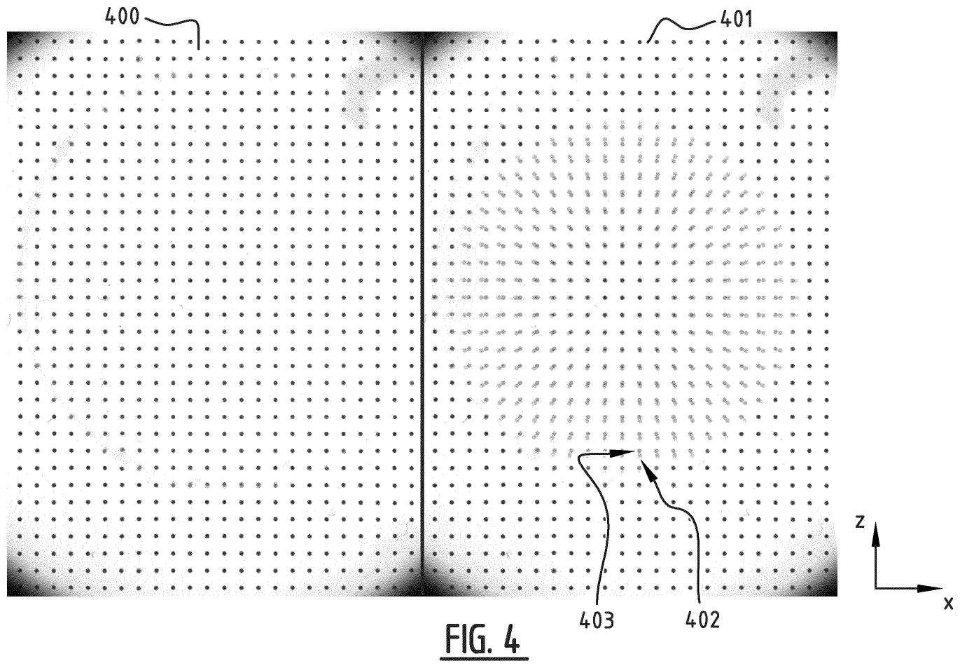

This may be illustrated in the FIG. 3A, illustrating a lens outline 300. Such a lens outline may be a lens comprising an electroactive lens as the electroactive lens 101 of FIG. 1. In the lens of FIG. 3, both the first electrode 106 and the Fresnel structure 102 provided on the second electrode 107 are provided with alignment layers, these alignment layers are aligned in the direction 306. This would presumably lead to alignment of the liquid crystals in direction 306 on both the first electrode 106 as well as on the Fresnel structure 102. However, the Fresnel structure 102 does not provide a surface that is parallel to the surface of the first electrode 106, as such, the surface of the Fresnel structure 102 affects the orientation of the liquid crystals thereon as schematically illustrated by arrows 301, 302, 303, 304 and 305. Even though the alignment in the middle of the lens outline 300 (illustrated by arrows 301) is parallel to the alignment direction 306, the alignment of the liquid crystals in the first left lower orientation 302 first right lower orientation 303, first left upper orientation 304 and first right upper orientation 305 have a substantial component that is not parallel to the rubbing direction (306). As such, applying a linear polarizer would not suffice to obtain a single image since the outgoing light comprises multiple polarizations that have traversed different refractive properties of the birefringent liquid crystals.

One might presume that the above could be resolved by placing a further electroactive lens such as element 101 of FIG. 1 on the electroactive lens of outline 300 to obtain the stack of two elements having outline 310 as in FIG. 3B. The description above also applies to the further electroactive lens, however the further electroactive lens would be aligned in direction 316 that is orthogonal to the alignment direction 306. Indeed, the first center orientation 301 is orthogonal to the second center orientation 311, and as such, polarization independent refraction is obtained near the center of the lens outline 310. However, remote from the center, for example, where the first left lower orientation 302 and second left lower orientation 312 overlap, their mutual alignment is not orthogonal resulting in different refractions for two different elliptical polarizations, therefore, in the region where the first left lower orientation 302 and second left lower orientation 312 overlap, the lens produces a double image. The same applies to the regions where the first right lower orientation 303 overlaps second right lower orientation 313, first left upper orientation 304 overlaps second upper orientation 314, and where first right upper orientation 305 overlaps second right upper orientation 315.

In other words light can be decomposed into two independent polarization states (twice linear, twice circular or twice elliptical) and unpolarized light includes a superposition of these two states. Liquid crystals consist of elongated molecules with different refractive index values along the different axes. When using a single lens cell and an ideal linear alignment direction on the top and bottom surface, in the on-state a linear polarization in the longitudinal direction of the molecules feel lens action and the other polarization orthogonal to said linear polarization will experience no lens action. The resulting image through the lens is thus a double image, both an enlarged and a non-enlarged image.

However, by placing a linear polarizer parallel to the linear alignment direction, the non-enlarged image can be filtered out. In the case of double stacked lens cells having an angle of 90 degrees, both polarizations will be increased and the incoming unpolarized light will be enlarged in its entirety. The reality, however, is that although linear alignment in lens cell is desirable, the lens introduces deviations. The result is that there is a place-dependent twist that causes a linear polarization to change into a location-dependent elliptical polarization (such as position-dependent elliptic polarization state illustrated in FIG. 3B). As a result, it is not possible to filter out the non-enlarged image with the aid of a linear polarizer. More specifically, the elliptical polarizations that arise from the independent linear polarizations (each of which includes an enlarged or no enlarged image, respectively) can no longer be disassembled with a linear polarizer.

Moreover, it is also difficult to make a completely polarization-independent lens with two stacked cells. After all, at each position one must be able to guarantee that the polarization change in both cells is the same but turned 90 degrees, which is not possible with two equal lens cells as illustrated in FIG. 3B.

FIG. 4 illustrates the image in a switched off state of an electroactive lens 101 such as the embodiment discussed in the light of FIG. 1. In the switched off state, the uniaxial liquid crystal molecules are preferably aligned in the axial direction of the electroactive lens 101, i.e. the direction substantially perpendicular to the surface of the first electrode 106. As such, in this state, the refractive index of the liquid crystals matches the refractive index of the Fresnel-lens structure 102. As such, no lens action is present in the switched off state. The image of a light screen comprising a plurality of black dots arranged in a recurring pattern (as seen through the electroactive lens 101) is illustrated in 401. Here, the dots of the screen are also seen as in a recurring pattern. The pattern 401 is the same pattern of the dots arranged on the screen.

If the electroactive lens 101 is switched on, the liquid crystals are preferably aligned in the radial direction, i.e. the direction substantially parallel to the surface of the first electrode 106. As such, the refractive index of the liquid crystals does not match the refractive index of the Fresnel-lens structure 102 and a lens action is obtained. The image of the light screen comprising a plurality of dots is enlarged as illustrated in image 401. However, the magnification is not the same for two orthogonal polarizations. For example the dots 402 and 403 are separate dots belonging to different polarizations, ideally these dots would coincide to form a single dot, that is, ideally, polarization independent magnification is obtained.

Since the problem mainly occurs in a state wherein an electric field is applied over the liquid crystal layer by the electrodes, the following description will relate to such a state unless clearly otherwise.

FIG. 5 illustrates an embodiment of an electroactive lens 501 wherein the above-identified problem has been addressed. The electroactive lens 501 substantially comprises the same components as the electroactive lens 101 of FIG. 1, like reference numerals (raised with 400) referring to like elements. In order to not obscure the disclosure, the same description, which also applies to this figure, is not repeated here. The electroactive lens 501 comprises (in the figure from top to bottom) a first substrate 504, a first electrode layer 506, an alignment layer 506, a cavity 508 filled with a layer of LC material 513 and a diffractive structure 502. a further alignment layer 512, a second electrode layer, and a second substrate 505. Additionally the electroactive lens 501 comprises polarizer layer 560 arranged between the first substrate 504 and the electrode layer 506.

FIG. 6 illustrates a further embodiment of an electroactive lens 801 in which the above-identified problem has been addressed as well. The electroactive lens 801 substantially comprises the same components as the electroactive lens 501 of FIG. 5, like reference numerals (raised with 300) referring to like elements. In order to not obscure the disclosure, the same description, which also applies to this figure, is not repeated here. Additionally the electroactive lens 801 comprises polarizer layer 860, the function of which will be explained later. The polarizer layer 860 in this embodiment is arranged on top of the first substrate 604 (i.e. at the outside surface of the first substrate 804).

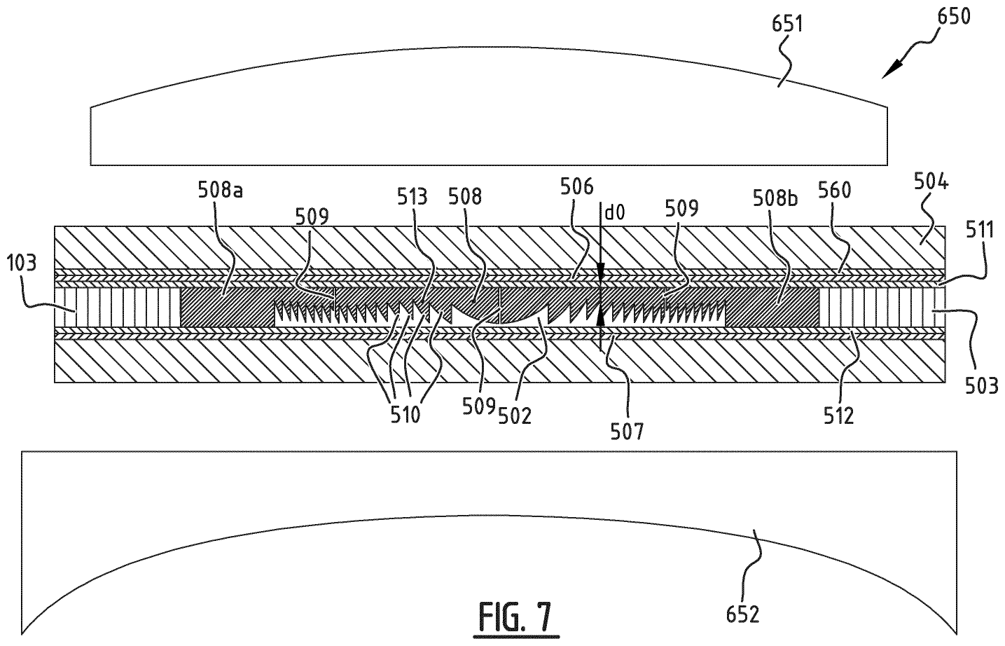

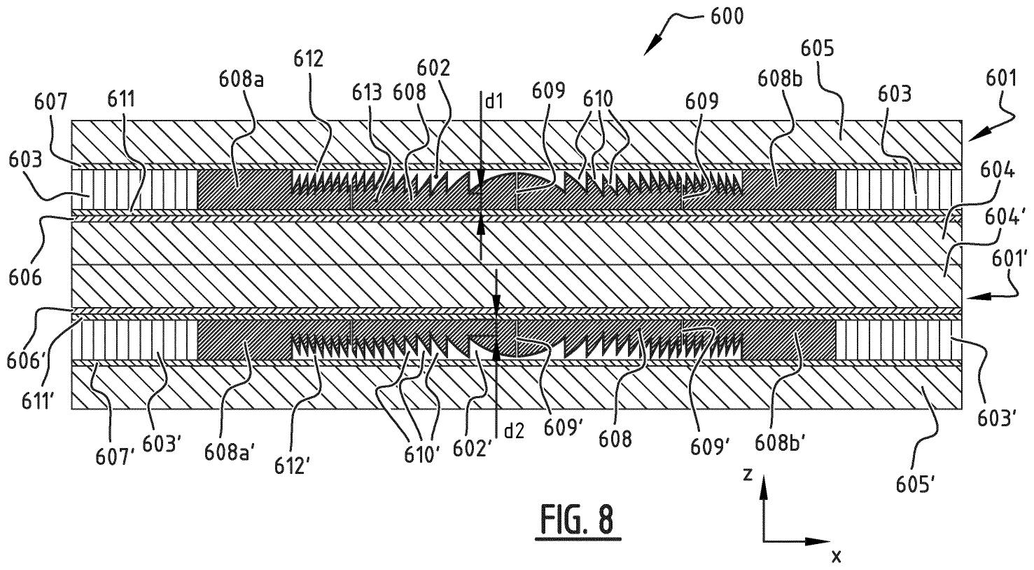

FIG. 7 shows an exploded view of a lens unit 650 comprised of the optical device of FIG. 5 arranged between two lens parts 651 and 652. Two of these lens unit 650 may be arranged in a frame of a pair of glasses to be worn by a person and allowing the person to change the optical power of the lens units between an off-state and on-state.

In the embodiments of FIGS. 5-7, a linear polarizer is provided forming a polarizer layer 560, 860. The polarizing layer is configured to allow a first linear polarization through and substantially block a second linear polarization orthogonal to said first linear polarization. Further, the polarizer layer is aligned such that the first linear polarization is substantially parallel to the alignment of the liquid crystals in the liquid crystal layer 508, 808 at the position near the first electrode 506, 806. For example, the linear polarizer 560, 860 may allow a polarization in a first transversal direction (for instance the x-direction) of an electromagnetic wave traveling in the axial (z) direction through while blocking a polarization in a second transversal direction (for instance the y-direction perpendicular to the first transversal direction and to the z-direction, i.e. perpendicular to the xz-plane). In this example, the alignment of the liquid crystals near the first electrode 506, 806, is in the x-direction. Further, a thickness d0 of the liquid crystal layer 508, 808, measured from the outer surface of any blaze 510 of the diffractive structure 502, 802 (or the outer surface of any blaze of the second alignment layer provided on top of the diffractive structure 502, 802) to the external surface of the alignment layers 561, 861 facing the cavity 508, 808), is such that the liquid crystal layer satisfies the Mauguin condition (equation 1). Hereby the double image 401 such as illustrated in FIG. 4 is prevented.

A person skilled in the art will recognize that the thickness d0 may also be chosen such that the Mauguin condition (equation 1) is not fully satisfied, however to some extend the waveguiding effect still takes place. For example, for thickness d0,

$$\frac{d 0 π Δ n}{ϕ λ} \approx f$$

wherein f≥1, a well known alternative condition of Gooch-Tarry for 90° twist can be used to evaluate the impact of the polarization state. The transmission of the such a twist cell placed between parallel polarizers is calculated as a function of thickness d (see Figure X). The transmission goes through a series if minima governed by the equation d=λ/Δn\sqrt{M²−0.25}, where M is an integer number [Ref: Gooch, C. H. and H. A. Tarry. “The optical properties of twisted nematic liquid crystal structures with twist angles less than or equal to 90 degrees” Applied Physics Vol. 8(1975): 1575-1584].

In many devices the first minimum of transmission is used for defining the required minimal thickness, however here the main disadvantage is that the first minimum holds only for a single wavelength. Physically this means that for the thickness of first minimum, the outcome polarization state is not purely linear for most other wavelengths. In general the polarization state will be elliptical with its major contribution still along the preferred direction (i.e. the alignment direction on the counter substrate). By increasing integer M and running the calculation for multiple wavelengths we obtain optimal d0 thicknesses with almost similar transmission values, and waveguiding condition can be considered as sufficiently satisfied. Thus, when substituting the thickness values in the left side of Mauguin condition, f may be found about 1, 2, 5 or 10 depending on the desired purity of the outcome polarization state, targeted wavelength range and birefringence of the LC material.

The above solution may still substantially solve the problem since the thickness of most regions of the liquid crystal layer 508 is substantially larger than d0, measured from the portion of the blazes 510 closest to the first electrode 506.

Further, the polarization layer 560 may be placed between the first substrate 504 and the first electrode 506 (as shown in FIG. 5), between the first electrode 806 and the first alignment layer 811 or on top of the first substrate 804 (FIG. 6).

In principle it also possible to provide a polarizer layer at the side of the second substrate 505, 805, for instance between the second substrate and the diffractive structure. In this case a location dependent quasi spherical polarizer layer should be added. Such a location dependent quasi spherical polarizer may be specifically formed so as to filter out one of a polarization direction of light emerging from the Fresnel-lens structure 502, 802 after passing through the first substrate 504, 804, the first electrode 506, 806, the alignment layer 511, 811 and the liquid crystal layer 508, 808. The location dependent quasi spherical polarizer would have a spherical shape so as to accurately filter a non-refracted polarization component of said emerging light. To this end the electroactive lens 501 would have a specified pattern. For example, referring to FIG. 3, the location dependent quasi spherical polarizer would, when integrated in the electroactive lens having outline 300, would block light having a polarization direction perpendicular to each of arrows 301, 302, 303, 304, and 305 at the location where each of arrows 301, 302, 303, 304, and 305 is respectively located. This would require for each thickness d0, each Fresnel-lens structure 502 and each liquid crystal layer to preform measurements on the polarization direction of the light emerging the Fresnel-lens structure 502 at each location thereof in the electroactive lens (in the xy-plane) and forming the location dependent quasi spherical polarizer according to such a measurement.

Further, also in the above described embodiment with the polarizer layer at the side of the second substrate, the second solution the thickness d0 of the liquid crystal layer, measured from the end of any blaze 510 to the opposing end (i.e. near the first electrode 506) of the liquid crystal layer 508, is such that the liquid crystal layer satisfies the Mauguin condition (equation 1). Hereby the double image such as illustrated in FIG. 4 is prevented.

A person skilled in the art will recognize that the thickness d0 may also be chosen such that the Mauguin condition (equation 1) is not fully satisfied, for example, the may be partially satisfied for thickness d0, i.e.

$$\frac{d 0 π Δ n}{ϕ λ} \approx f$$

wherein f≥1, such as for example, f may be about 1, 2, 5, 10, or, preferably, between 5 to 10, or >10. The above solution may still substantially solve the problem since the thickness of most regions of the liquid crystal layer 508 is substantially larger than the d0, measured from the portion of the blazes 510 closest to the first electrode 506.

The person skilled in the art will recognize that the first and second solution may be combined. This may adequately solve the problem discussed above. In some embodiments however, having two polarizing layers, reducing the transmitted intensity of the light, may not be preferred.

FIG. 8 illustrates a third solution to the problem above. In the embodiment of this figure, the electroactive lenses 601 and 601′ substantially comprise the same components as the electroactive lens 101 of FIG. 1 (i.e. a lens without one or more polarizer layers), like reference numerals referring to like elements (raised with the number 500). In order to not obscure the disclosure, the same description, which also applies to this figure, is not fully repeated here.

FIG. 8 shows an optical device 600 comprising a first electroactive lens 601 and a second electroactive lens 601′ stacked on top of the first electroactive lens 601. Similar to the electroactive lens 101 of FIG. 1, each of the first and second electroactive lenses 601, 601′ comprises a first optically transparent substrate 604, 604′ and a second optically transparent substrate 605, 605′. The first and second optically transparent substrates 604, 604′, 605, 605′ extend generally parallel to each other and define an axial (z) direction and transverse (x,y) directions, as is indicated in the figure. The first and second electroactive lenses 601, 601′ are stacked in such a manner that the second substrates 605, 605′ of each of the electroactive lenses 601, 601′ are at an outside of the stack and each of the first substrates 604, 604′ are arranged at an inside of the stack.

The first electroactive lens 601 and the further electroactive lens 601′ are in optical communication, that is, the second substrate 604 and the further second substrate 604′ are optically coupled such that there is preferably no optical interface between the two substrates. Similar to the electroactive lens discussed in the light of FIG. 5, the first and further electroactive lens 601 and 601′ have a thickness d1 and d2, respectively, as measured from the diffractive structure 602 or 602′ (or the alignment layer 612, 612′ provided thereon) to the alignment layer 611, 611′ of the electrode opposite the diffractive lens structure, i.e. electrode 606 of the first electroactive lens 601 or electrode 606′ of the second electroactive lens 601′, respectively. Each of thicknesses d1 and d2 is such that the liquid crystal layer 613 of the first electroactive lens 601 and liquid crystal layer 613′ of the second electroactive lens 601′ satisfy the Mauguin condition (equation 1). Hereby, the double image 401 such as illustrated in FIG. 4 is prevented or at least reduced to a considerable extent.

The first electrode 606 and further first electrode 606′ comprise an alignment layer 611,611′ respectively, for instance a polyimide layer treated with e.g. rubbing. The alignment of liquid crystals on the opposing surfaces of the alignment layers 611 and 611′ is mutually orthogonal. For example, the liquid crystals in the first liquid crystal layer 613 are aligned in the x-direction on the surface near the alignment layer 611 of the first electrode 606, while the liquid crystals in the second liquid crystal layer 613′ are aligned in the y-direction (not shown, perpendicular to the x- and z-direction) on the surface near the alignment layer 611′ of the further first electrode 606′. Thereby, if a first polarization of light incident on the first electroactive lens 601 is magnified by the first electroactive lens 601 while a second polarization (being orthogonal to the first polarization direction) of the light incident on the first electroactive lens 601 is not magnified, the magnified first polarization of light incident on the further electroactive lens 601′ is not further magnified by the further electroactive lens 601′ while the second polarization of the light incident on the further electroactive lens 601′ is magnified. Hereby the first electroactive lens 601 and the further electroactive lens 601′, constituting the optical device 600, jointly provide a polarization independent magnification.

For manufacturing purposes, it may be preferred if d1 and d2 are the same or even that the first electroactive lens 601 and the further electroactive lens 601′ are substantially identical. Thereby, both elements may be formed using the same parameters for the production method. However, in some embodiments d1 and d2 may be different (i.e. the blaze heights may be different in case the diffractive lens element is a Fresnel lens element). Even the blaze positions of the Fresnel lens element of the first electroactive lens may differ from the blaze positions of the Fresnel lens element of the second electroactive lens. For instance, the blaze heights may be slightly different in both electroactive lenses when the blaze edges do not need to be exactly aligned. In preferred embodiments, however, the optical power of the first electroactive lens 601 is the same as the optical power of the second electroactive lens 601′.

This third solution may provide the advantage over the first and second solution that the intensity of light incident on the electroactive lenses 601 an 601′ is substantially conserved while the first and second solutions reduce the intensity of light due the at least one polarizer. On the other hand, the unit according to the first and second solutions may be relatively thinner than the third solution. Depending on the application, either of the first, second, third or any combination thereof may be applied.

Depending on the dimensions of the electroactive lens and the desired optical quality, the alignment layer (for instance, alignment layer 512) on top of the diffractive lens structure may include a pretilt as well, the alignment layer having its preferential direction parallel with the linear alignment direction of the alignment layer on the first electrode. Introducing this pretilt will generally reduce the twist angle values and thus increase the Mauguin condition value. This will lead to better optical performance.

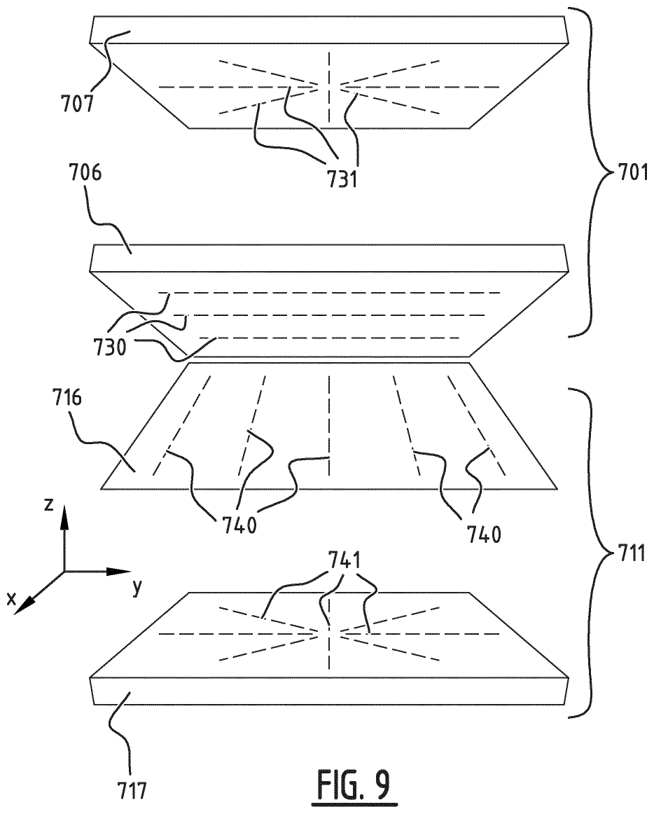

FIG. 9 is a schematic exploded view of the electroactive unit of FIG. 8. Herein several components are omitted for sake of explanation. The first electroactive lens 701 and further electroactive lens 711 are in reality in optical communication.

In between the second electrode 707 and the first electrode 706 the liquid crystal layer and the Fresnel-lens structure are disposed (not shown). The distance between the second electrode 707 and the first electrode 706 is such that the liquid crystals disposed there between satisfy the Mauguin condition (equation 1). The first electrode 706 is provided with an alignment layer schematically illustrated by 730. Since the liquid crystals are aligned parallel to the alignment direction 730 on the first electrode 706. On the second electrode 707, the liquid crystals may, due to the geometry of the first Fresnel-lens structure (not shown) align according to the schematic pattern 731. This schematic pattern may be star-shaped, starting from the centre. Please note that the alignment pattern on the second electrode 707 may also be different due to, for example, rubbing of the surface in contact with the liquid crystals close to the second electrode 707 (e.g. the surface of the Fresnel-lens structure or the electrode 707 or a layer (not including the liquid crystal layer) provided thereon). For example, due to rubbing of the surface close of the electrode 707 the alignment on said electrode may resemble the alignment discussed in the light of FIG. 3A.

In between the further second electrode 717 and the further first electrode 716 the liquid crystal layer and the Fresnel-lens structure are disposed (not shown). The distance between the further second electrode 717 and the further first electrode 716 is such that the liquid crystals disposed there between satisfy the Mauguin condition (equation 1). The further first electrode 716 is provided with an alignment layer schematically illustrated by 740. Since we want to obtain a uniform linear polarization state at the further first electrode 716, the liquid crystals in the further electroactive lens 711 will align parallel to the alignment direction 740 on the further first electrode 716. On the further second electrode 717, the liquid crystals may, due to the geometry of the second Fresnel-lens structure (not shown) align according to the schematic pattern 741. Please note that the alignment pattern on the further second electrode 717 may also be different due to, for example, rubbing of the surface in contact with the liquid crystals close to the further second electrode 717 (e.g. the surface of the Fresnel-lens structure or the electrode 717 or a layer (not including the liquid crystal layer) provided thereon). For example, due to rubbing of the surface close of the electrode 717 the alignment on said electrode may resemble the alignment discussed in the light of FIG. 3A.

The alignment of the first alignment direction 730 relative to the further first alignment direction 740 is orthogonal. Thereby, as disused above, if a first polarization is magnified by the first electroactive lens 701 and a second polarization direction (orthogonal to the first polarization direction) is not magnified, the second polarization is magnified by the further electroactive lens 711 and the first polarization direction (orthogonal to the first polarization direction) is not magnified. Thereby both orthogonal polarization directions are magnified and polarization independent magnification is achieved.

### Exemplary Embodiments

In the following non-limitative examples, the example, the lens diameter is 21 mm, i.e. the Fresnel-lens structure (such as 102, 502, 602, and 612) has a diameter in the x- and y-direction, both being 21 mm.

In addition to the birefringence of the liquid crystal and the maximum twist in the cell, the thickness of the cell is an important parameter. In order to ensure that the Mauguin regime is achieved throughout the lens, and the thickness varies within a Fresnel blaze, it is important to design the spacer height on top of the Fresnel-lens structure sufficiently high. In this way, this regime is preferably also reached above the highest point of a blaze.

Using this regime, it is even possible to fully specify the linear alignment direction on the lens surface, and only use the circularly symmetric alignment resulting from the application of a homeotropic alignment layer that is not rubbed or receives a photoalignment treatment. Nevertheless, this may still be the case in some embodiments. After all, there is a trade-off between the spacer height on top of the lens, the degree to which the Mauguin regime is achieved, and the switching voltage and speed of the lens. A lens cell with a certain spacer height and a (quasi-) linear alignment direction (as in FIG. 3A) on the lens surface will have a better optical quality than the same lens cell with a circularly symmetrical alignment direction on the lens surface because the first one is deeper in the Mauguin regime. A lens cell with (quasi) linear alignment direction and smaller spacer height than a lens cell with a circularly symmetrical alignment direction can have similar optical quality, but switch faster between an off and an on state.

To test the electroactive lenses a Hartmann test was used. Using the contrast values of a matrix of projected dots (such as in FIG. 4), the quality of the electroactive lenses was determined. In the following examples, an electroactive lens is divided from inside to outside in three concentric zones: C1, C2 and C3. The average contrast value over an entire zone summarizes the quality in the entire zone.

### Example 1 (not According to the Present Disclosure)

A Hartmann-test image of an electroactive lens in the off-state with almost no Mauguin regime. This electroactive lens has a blaze height of 16 microns, an additional spacer height of 3 microns and has a liquid crystal with Δn=0.2. The electroactive lens was rubbed on both sides of the liquid crystal layer. Presumably the LC is linearly aligned on a top substrate, the alignment direction a lower substrate (near the Fresnel-lens structure) the alignment approximates the alignment as in FIG. 3A. The results of the off state are illustrated in FIG. 4, item 400. In the on state the image resembles item 401, here the non-enlarged and the enlarged image are superimposed on each other.

### Example 2 (not According to the Present Disclosure)

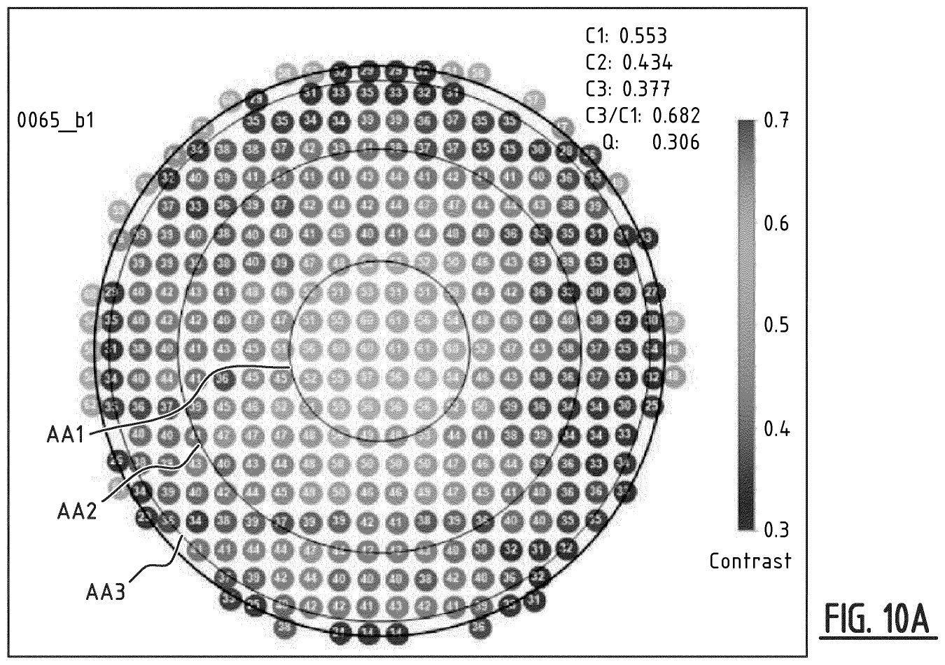

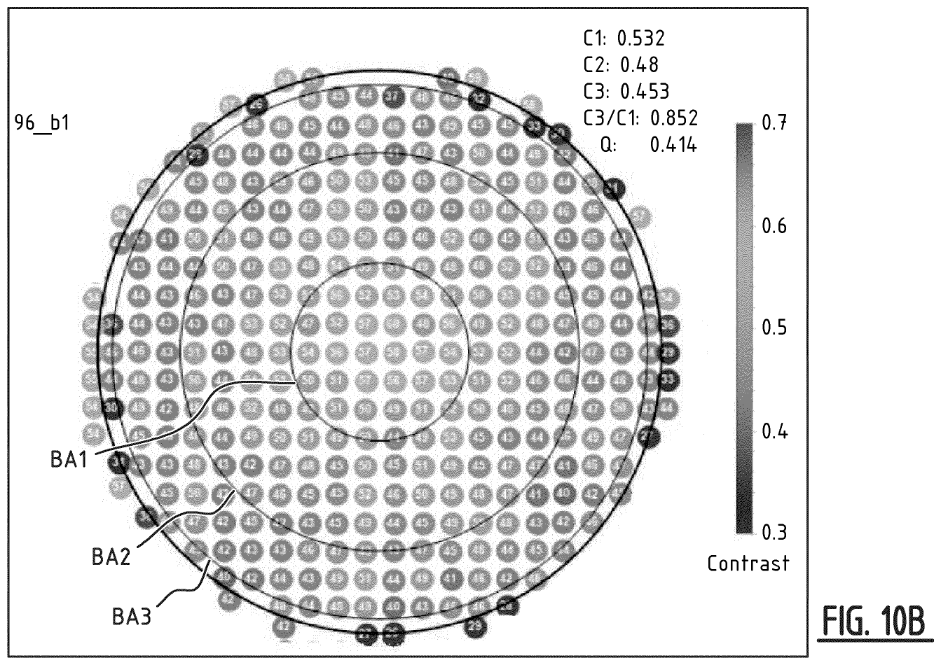

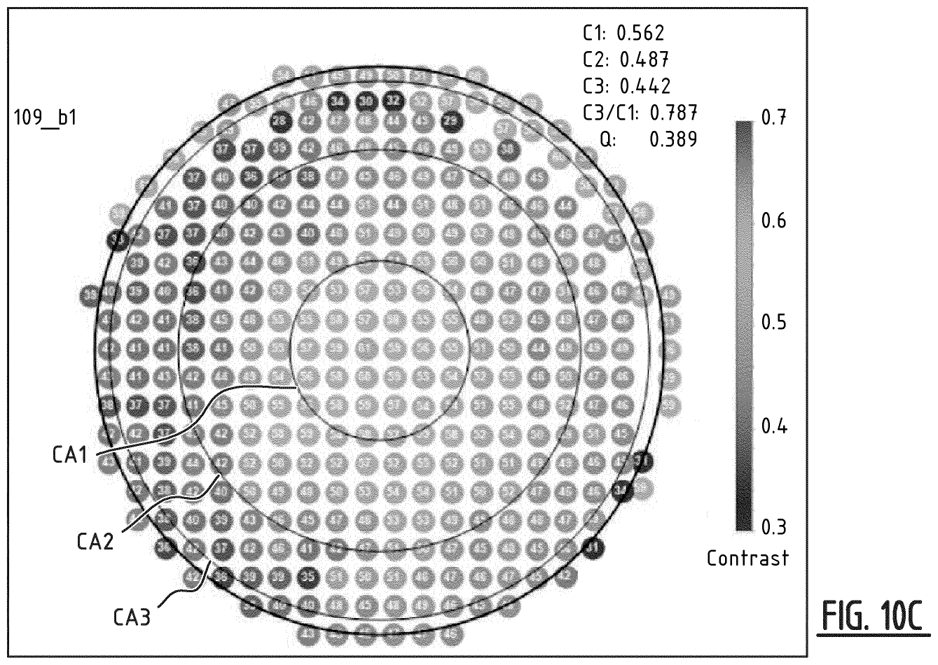

An electroactive lens in the off-state with almost no Mauguin regime (FIG. 10A). The electroactive lens of this example is substantially the same as the electroactive lens of example 1. FIG. 10A illustrates the on-state, supplemented with the contrast values of the individual contrast values of the dots of the Hartmann test. The results are obtained using with a linear polarizer on the side of the upper substrate, parallel to the linear alignment direction of the upper substrate. As can be seen from the values C1, C2 and C3, the contrast values are only moderate.

As can be derived from FIG. 10A the value of C1 is 0.553 and corresponds to region AA1, the value of C2 is 0.434 and corresponds to region AA2, the value of C3 is 0.377 and corresponds to region AA3.

### Example 3 (According to the First Solution of the Present Disclosure)

An electroactive lens in the on-state in the Mauguin regime (FIG. 10B). This example relates to an electroactive lens in the Mauguin regimen wherein the surface of the Fresnel-lens structure was rubbed. The blaze height is 15 microns, there is an additional spacer height of 10 microns and Δn=0.25. The electroactive lens is measured with a linear polarizer on the side of the upper substrate, parallel to the linear alignment direction of the opposing electrode substrate. The electroactive lens has the best contrast values (of the examples 2-4) because the maximum twist in the electroactive lens is limited.

As can be seen from FIG. 10B the value of C1 is 0.532 and corresponds to region BA1, the value of C2 is 0.48 and corresponds to region BA2, the value of C3 is 0.453 and corresponds to region BA3.

### Example 4 (According to the First Solution of the Present Disclosure)

An electroactive lens in the on-state in the Mauguin regime (FIG. 10C). This example relates to an electroactive lens in the Mauguin regime wherein the surface of the Fresnel-lens structure was not rubbed. The blaze height is 15 microns, there is an additional spacer height of 10 microns and Δn=0.25. The electroactive lens is measured with a linear polarizer on the side of the upper substrate, parallel to the linear alignment direction of the opposing electrodes. The electroactive lens exhibits better contrast values than the second example, mainly at the outer C3 zone.

As can be seen from FIG. 10C the value of C1 is 0.562 and corresponds to region CA1, the value of C2 is 0.487 and corresponds to region BA2, the value of C3 is 0.442 and corresponds to region CA3.

From the examples above it can be objectively and quantitatively demonstrated that the present disclosure does improve the quality of electroactive lenses.

It is to be understood that this disclosure is not limited to particular aspects described, and, as such, may vary. It is also to be understood that the terminology used herein is for the purpose of describing particular aspects only, and is not intended to be limiting, since the scope of the present disclosure will be limited only by the appended claims.

1. An optical device for use in eyewear, the optical device comprising a first electroactive lens for a tunable transmission of light, the electroactive lens comprising:
a first and a second optically transparent substrate, wherein the first and second optically transparent substrates extend generally parallel to each other and define an axial (z) direction and transverse (x,y) directions;
a diffractive lens structure, such as a Fresnel lens structure, arranged between the first and second optically transparent substrate at a side of the second optically transparent substrate;
a first optically transparent electrode formed on the first optically transparent substrate and a second optically transparent electrode formed on the second optically transparent substrate or on the diffractive lens structure;
a sealed cavity between the first and second optically transparent substrates, wherein in the sealed cavity, the diffractive lens structure and at least an LC layer of nematic liquid crystalline (LC) material are arranged and wherein liquid crystals in the nematic liquid crystalline (LC) material are generally axially aligned in an off-state, wherein the first optically transparent electrode comprises an alignment layer having a contact surface in contact with the LC layer and configured to linearly align liquid crystals in the nematic liquid crystalline material in a first horizontal direction in an on-state by introducing a pretilt in the off-state; and
a polarization element configured for adjusting light having a polarization in a second horizontal direction perpendicular to the first horizontal direction;
wherein the LC layer of nematic liquid crystalline material has a thickness (D), measured between a portion of the diffractive lens structure closest to the first optically transparent electrode and the contact surface of the alignment layer on the first optically transparent electrode, and
wherein the thickness (D) is selected to satisfy a condition 1<(πD(nₑ−nₒ)/(φλ)<200, nₒ being an ordinary refractive index of the LC layer, nₑ an extraordinary refractive index of the LC layer, φ a twist angle of a liquid crystal director of the LC layer and λ a wavelength of the light, the wavelength λ ranging between 350 nm and 750 nm.

2. The optical device of claim 1, wherein the diffractive lens structure arranged between the first and second optically transparent substrate at the side of the second optically transparent substrate is arranged at the second optically transparent electrode.

3. The optical device of claim 1, wherein the polarization element comprises a second electroactive lens stacked on the first electroactive lens, wherein the second optically transparent substrate of the first electroactive lens comprises an alignment layer having a contact surface in contact with the LC layer and configured to linearly align liquid crystals in the nematic liquid crystalline material in a first horizontal direction and the second optically transparent substrate of the second electroactive lens comprises an alignment layer having a contact surface in contact with the LC layer and configured to linearly align liquid crystals in the nematic liquid crystalline material in a second horizontal direction, wherein the first direction is perpendicular to the second horizontal direction.

4. The optical device of claim 3, wherein the first and second electroactive lenses are stacked with their respective first optical transparent substrates facing each other and/or wherein the first and the second electroactive lenses are mutually stacked such that the second substrates are arranged at an outside of the stack and the first substrates are arranged at an inside of the stack.

5. The optical device of claim 3,
wherein the first optical transparent substrate of the first electroactive lens and the first optical transparent substrate of the second electroactive lens are combined into a single, common optical transparent substrate, or
wherein optical power of the first electroactive lens corresponds to optical power of the second electroactive lens.

6. (canceled)

7. The optical device of claim 3, wherein the diffractive lens structure is a Fresnel lens structure and wherein a blaze axial heights and/or a blaze transversal positions of the Fresnel lens structure of the first electroactive lens differ at least partially from the blaze axial heights and/or the blaze transversal positions of the Fresnel lens structure of the second electroactive lens.

8. The optical device of claim 3, wherein the diffractive lens structure of the first electroactive lens faces the diffractive lens structure of the second electroactive lens.

9. The optical device of claim 3,
wherein the first and second electroactive lenses are identical, or
wherein the nematic liquid crystalline material of the first electroactive lens differs from the nematic liquid crystalline material of the second electroactive lens.

10. (canceled)

11. The optical device of claim 1, further comprising:
a linear polarizer configured to allow light with a first linear polarization through and substantially block light with a second linear polarization perpendicular to the first linear polarization,
wherein the polarizer is aligned in such a manner that the first linear polarization is substantially parallel to the alignment of the liquid crystals in the liquid crystal layer at a position near the first electrode.

12. The optical device of claim 11, wherein the first linear polarization is parallel to a first transverse direction (x) and the second linear polarization is parallel to a second transverse direction (y), perpendicular to the first transverse direction.

13. The optical device of claim 11, wherein the linear polarizer comprises one or more polarizing layers attached to the first substrate and/or to the first optically transparent electrode, preferably comprising a polarizing layer attached to the alignment layer and aligned to the alignment direction of the alignment layer.

14. The optical device of claim 11,
further comprising at least one polarizing layer formed on the surface of the diffractive lens structure facing the LC layer, wherein a polarizing director of the at least one further polarizing layer is tuned in different areas of the diffractive lens structure in such a way that it matches a local liquid crystal director on the lens surface, and/or
wherein a diffractive element or the second optically transparent electrode comprises a further alignment layer configured to linearly align liquid crystals in the nematic liquid crystalline material in the first horizontal direction in an on-state by introducing a pretilt in the off-state.

15. (canceled)

16. The optical device as claimed in claim 1,
wherein at least one electroactive lens is configured to tune a focusing or dispersing of light by altering an alignment of liquid crystals in the LC layer, upon application of a voltage to the optically transparent electrodes, or
wherein the at least one electroactive lens is configured to vary optical power of the electroactive lens by altering the refractive index of the LC layer in the transverse direction upon application of a voltage to the optically transparent electrodes.

17. (canceled)

18. The optical device of claim 16, wherein the optical device is configured to cause the at least one electroactive lens to switch from an the off-state wherein the at least one electroactive lens shows essentially no lens action and an on-state wherein the at least one electroactive lens shows lens action upon application of a voltage to the optically transparent electrodes of the at least one electroactive lens.

19. The optical device of claim 1, wherein in the off-state the liquid crystals in the nematic liquid crystalline material are orientated such that the refractive index of the LC layer in the transverse direction essentially matches the refractive index of the diffractive structure and/or wherein in the on-state the orientation of the liquid crystals is tilted so that the orientation becomes parallel with the alignment direction of the alignment layer.

20. The optical device of claim 1,
wherein a diffractive element on the second optical transparent electrode is provided with an alignment layer facing the LC layer, and/or
wherein the optical transparent electrodes of the electroactive lenses are electrically connected for simultaneous switching of the first and the second electroactive lenses.

21. (canceled)

22. The optical device of claim 1, wherein a plurality of spacers are arranged in the liquid crystal layer, extending in a direction perpendicular to a plane wherein the second electrode extends, which spacers are formed on the diffractive lens structure.

23. The optical device of claim 22, wherein the spacers are configured to provide an additional height, measured from the portion of the diffractive lens structure closest to the second substrate, being between 1-20 μm.

24. The optical device of claim 1,
wherein the liquid crystal material of at least one of the electroactive lenses has a birefringence Δn that is in the range of 0.15-0.40, and/or
wherein the optical device is configured to provide a polarization-independent transmission of light.

25. (canceled)

26. (canceled)

27. (canceled)

28. (canceled)

29. A method of operating an optical device as claimed in claim 3, wherein an alternating voltage is applied onto the first and second electrode of the first electroactive lens and of the second electroactive lens stacked onto the first electroactive lens, so as to align the liquid crystals in a direction substantially perpendicular to the first and second substrates.
